(19) United States
(12) Patent Application Publication
(10) Pub. No.: US 2017/0363246 A1
(43) Pub. Date: Dec. 21, 2017

(54) FLOW-THROUGH PIPING CAP

(71) Applicant: DOBBER INDUSTRIES, LLC, Cleveland, TX (US)

(72) Inventor: DARWIN D. BRYANT, CLEVELAND, TX (US)

(73) Assignee: DOBBER INDUSTRIES, LLC, CLEVELAND, TX (US)

(21) Appl. No.: 15/186,816

(22) Filed: Jun. 20, 2016

(51) Int. Cl. F16L 55/24

(52) U.S. Cl. CPC F16L 55/24

(57) ABSTRACT

A pipe cap and methods for using the pipe cap are provided. The invention includes a pipe cap, which can include a body having one or more openings disposed therein. The pipe cap can also include a connector, and the connector can be configured to connect to a drain pipe. The pipe cap can be configured to prevent insects and animals from entering and clogging fluid drainage systems, e.g., HVAC systems.

### BACKGROUND

### Field

This invention relates to the general field of building construction. More specifically, this invention relates to the field of piping and the flow of fluid (air, water, etc.) from a building through a piping or vented system.

### Description of the Related Art

This invention relates to protection of piping or other fluid flow systems in residential and commercial building structures. For example, this invention can relate to a residential or commercial air conditioning systems used to produce cold air, condensation builds up in the system and drains through a series of tubes to an outlet located on the buildings exterior. Most drain pipe systems are comprised of copper or PVC (polyvinyl chloride) piping. Most common, a draining system is connected to a unit condenser, where the draining system is used to remove water that is regularly produced during operation of the air conditioning through the condensation process.

A condenser in an HVAC system usually includes an inside unit containing a cold evaporator coil designed to cool air as the air passes over the coils. Condensation, water droplets, form on the evaporator coils, and the condensation collects by dripping off of the coils and into a drain pan.

The liquid (e.g., water) produced from the condensation is often in such quantities that it must be constantly removed, and often is drained through a pipe which transports the water from the point of condensation to a terminal pipe, or drainage pipe, protruding from the side of the building, whereby the water runs freely out of the end of the pipe. Problems often occur, however, with an open ended pipe protruding from the building. For example, small insects and animals are able to enter the pipe and build nests or otherwise cause the piping to be clogged. A clogged pipe can cause thousands of dollars in damage due to backed up water. Current unclogging techniques include the use of highly concentrated chemical washes as well as plumbing snakes and augers, each of which can be difficult to perform and harmful to the water draining system.

Accordingly, a need exists for a device to prevent clogging in fluid drainage systems.

### SUMMARY

A pipe cap is designed for use in water drainage systems used in residential and commercial buildings. For example, the pipe cap is helpful to prevent problems in the condensate drainage system of a building's HVAC system (otherwise known as the heating, ventilation, and air conditioning system). These problems may include clogging of the drainage system due to insects and/or small animals entering the drainage system, often through an open ended pipe (referred to herein as the “drain pipe”) at a point external to the building, and clogging the system. To prevent these and other clogging problems from occurring, a pipe cap may be used to allow water to continue to flow out of the drainage pipe while simultaneously preventing insects and animals from entering the drain pipe.

The pipe cap can have an elongated body with a first end and a second end. The body of the pipe cap can be generally cylindrical and configured to connect to a pipe end or hosing end or draining terminus. The first end of the pipe cap can include a cap terminus face that includes one or more holes disposed therethrough so that a fluid can pass through the cap terminus while larger solids are blocked from passage. The pipe cap offers a plurality of advantages to current drainage systems. For example, by letting fluid flow through the pipe cap in a first direction, the cap terminus of the pipe cap can keep solids from traveling through the pipe cap in either direction.

### BRIEF DESCRIPTION OF THE DRAWINGS

FIG. 1 depicts a side view of a pipe cap, according to one or more embodiments described.

FIG. 2 depicts a side view of a pipe cap, according to one or more embodiments described.

FIG. 3 depicts a front side view of a pipe cap, according to one or more embodiments described.

FIG. 4A depicts a side view of a pipe cap and a channel having a flange, according to one or more embodiments described.

FIG. 4B depicts a side view of a pipe cap connected to a channel having a flange, according to one or more embodiments described.

FIG. 5 depicts a building overhang, a channel having a flange, and a pipe cap, according to one or more embodiments described.

FIG. 6 depicts a building overhang, a channel, and a pipe cap, according to one or more embodiments described.

FIG. 7 depicts a building overhang having a plurality of drain pipes protruding therefrom, with a single pipe cap connected to each drain pipe according to one or more embodiments described.

FIG. 8 depicts a side view of a pipe cap, according to one or more embodiments described.

FIG. 9 depicts a cross-sectional view of a pipe cap connected to a drain pipe, according to one or more embodiments described.

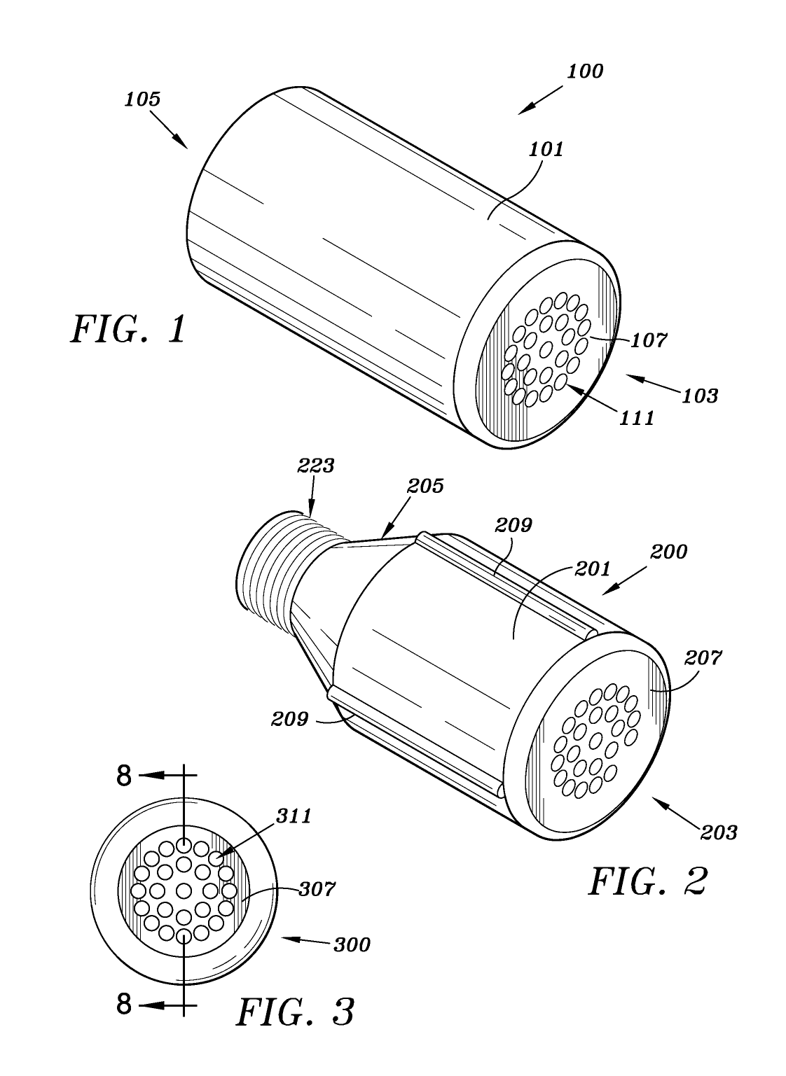

### DETAILED DESCRIPTION

A design and method for using a pipe cap 100 is provided. A pipe cap 100 is designed for use in water drainage systems used, at least, in residential and commercial buildings. The pipe cap can have a main body 101 having a first end 103 and a second end 105. The main body 101 can have an elongated shape. The main body 101 can have a shape generally or exactly reflecting a cylinder, a rectangular prism, a cube, a pyramid, a cone, a hexagonal prism, a hexagonal cone, and/or a sphere.

The pipe cap 100 can include a face 107 disposed about the first end 103. The first end 103 and/or the face 107 can include one or more openings 111. The one or more openings 111 can otherwise be referred to as “hole(s)” when appropriate. The opening 111 can vary in size and shape. For example, the opening 111 can be square, circular, rectangular, triangular, or any combination thereof. In another example, the one or more openings 111 can be circular in shape having a diameter of about 1 millimeter, about 2 millimeters, about 3 millimeters, about 4 millimeters, about 5 millimeters, about 6 millimeters, about 7 millimeters, about 8 millimeters, about 9 millimeters, or about 10 millimeters. In another example, the opening can have a diameter of about 1 inch, about 2 inches, about 3 inches, about 4 inches, about 5 inches, about 6 inches, about 7 inches, about 8 inches, about 9 inches, or about 10 inches.

The pipe cap 100 can include one or more openings 111, two or more openings 111, three or more openings 111, four or more openings 111, five or more openings 111, six or more openings 111, seven or more openings 111, eight or more openings 111, nine or more openings 111, ten or more openings 111, eleven or more openings 111, twelve or more openings 111, thirteen or more openings 111, fourteen or more openings 111, fifteen or more openings 111, sixteen or more openings 111, or seventeen or more openings 111.

In one or more embodiments, the face 107 can include a pattern of one or more openings 111 sufficient to prevent solid objects from traveling through the openings 111. Accordingly, the size of the one or more openings 111 can be varied for the prevention of these solid objects from passing through the face 107 and/or the first end 103. For example, the openings 111 can be sized to allow small grains of sand to pass through but block the passage of pebbles and/or rocks. In another example, the one or more openings 111 can be sized to allow a flea to pass through but block the passage of a dirt-dauber or wasp.

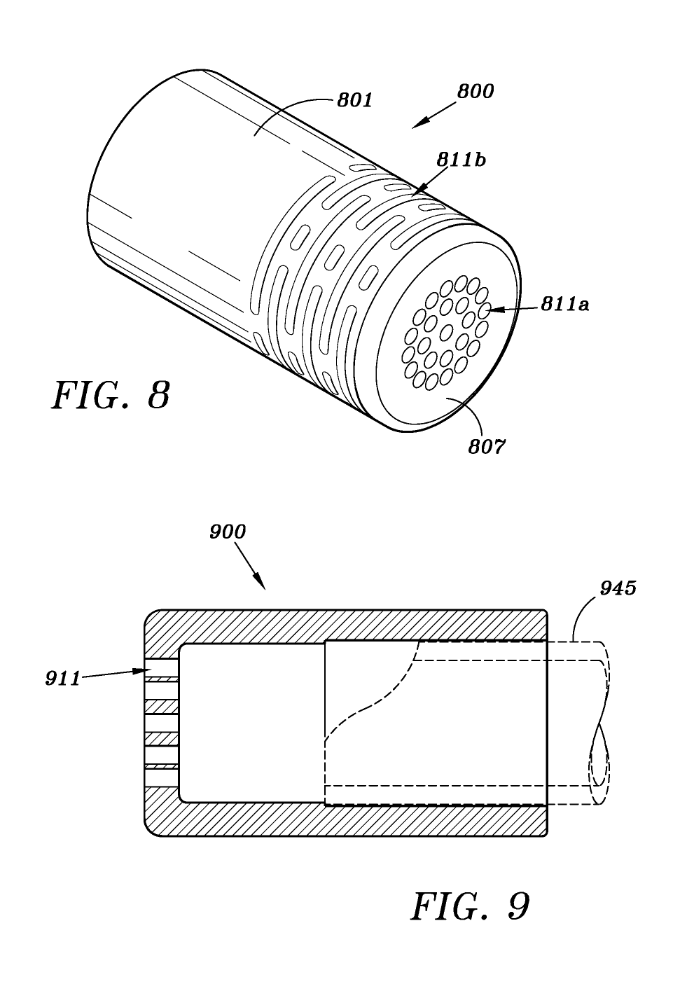

The one or more openings 111 can be disposed through the main body 101 of the pipe cap 100. The one or more openings 111 can be disposed through the walls of the main body 101 at or about the first end 103, at or about the second end 105, at or about the face 107, or any combination thereof. For example, as shown in FIG. 8, the one or more openings 111 can be disposed through the walls of the main body 101 at or near the first end 103 of the pipe cap 100.

As shown in FIG. 2, a pipe cap 200 can include a main body 201 having a first end 203 and a second end 205, and the second end 205 of the pipe cap 200 can be configured to connect to a pipe or piping structure. The pipe cap 200 can include a face 207 disposed at or about the first end 203, and one or more openings can be disposed therethrough.

The main body 201 can include a connector 223 disposed about the second end 205 of the main body 201. The connector 223 can be configured to connect or otherwise attach the pipe cap 200 to a drain pipe (not shown). The connector 223 can be a threaded and/or “male” connector configured to connect to a threaded and/or “female” receptacle. Alternatively, the connector 223 can be a threaded and/or female receptacle configured to connect to a threaded and/or “male” connector. One or more ridges 209 can be disposed on the main body 201 of the pipe cap 200 to allow a user to more easily handle the pipe cap 200.

FIG. 3 depicts a front side view of a pipe cap 300. One or more openings 311 can be disposed on a face 307 of the pipe cap. As shown, the openings 311 can be collectively arranged in a circular pattern on the face 307 of the pipe cap 300.

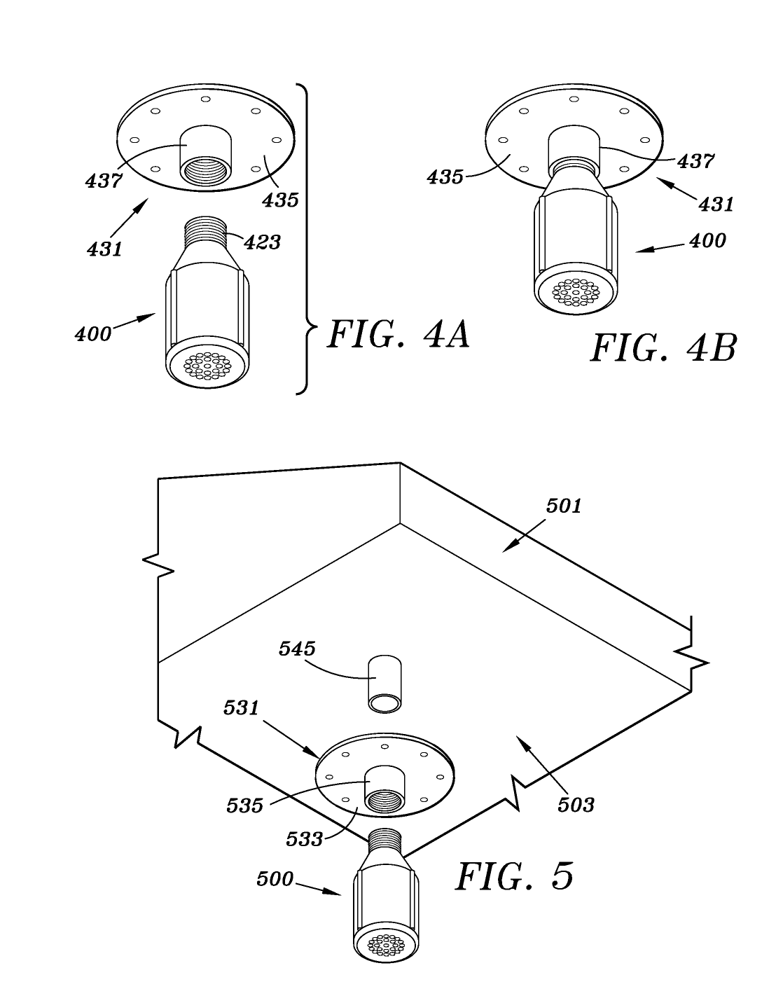

As shown in FIGS. 4A and 4B, at least one embodiment of a pipe cap 400 can be threadably connected to or otherwise attached to a conduit 431. Specifically, the pipe cap 400 can be connected to the conduit 431 by axially rotating the pipe cap 400 such that the threads of the pipe cap connector 423 interlock with the threads of the conduit 431. The conduit 431 can include a flange 435 having a channel 437 disposed therethrough. In at least one embodiment, the channel 437 can include a hole disposed through the flange 435, including a hole disposed through the flange 435 at the center of the flange 435. In at least one other embodiment, the channel 437 can include a piece of tubing or pipe extending outward from the flange 435, and such protruding piece can be configured to attached or connect to the pipe cap 400 (as shown in FIGS. 4A-4B). A portion of the channel 437 can be threaded, glued, or otherwise permanently or temporarily attached to the pipe cap 400.

Drainage pipes are often found protruding through an outer wall of a building or structure. Most common, such a drainage pipe protrudes from the side of the building or from an overhang portion of a roof by several inches, so that fluid may drain out of the building without causing damage or staining to the outer wall of the building. In some situations, though, the water drainage pipe is flush with the side of the building or overhang portion of the roof, wherein the pipe cap can be attached to the drainage pipe at a position interior to the outer wall. In some circumstances, it may be more beneficial to connect an extension conduit onto the drainage pipe and then connect the pipe cap to the extension conduit. In some circumstances, the drainage pipe may not be threaded and configured to connect to a threaded connector on the pipe cap. To remedy this, a conduit may be used, attaching a first end of the conduit to the drain pipe and attaching a second end of the conduit that is threaded to the threaded connector of the pipe cap.

As shown in FIG. 5, the pipe cap 500 can be configured to attach to the conduit 531 having a flange 533, and the conduit 531 can be configured to attach to the drainage pipe 545. In this configuration, and those like it, the flange 533 of the conduit 531 can be used to secure and stabilize the pipe cap 500. For example, the flange 533 can be secured to the overhang 503 portion of a roof 501 by nailing, screwing, or otherwise securing the flange 533 to the overhang 503. The conduit 531 can include a flange 533 having a channel 535 disposed therethrough.

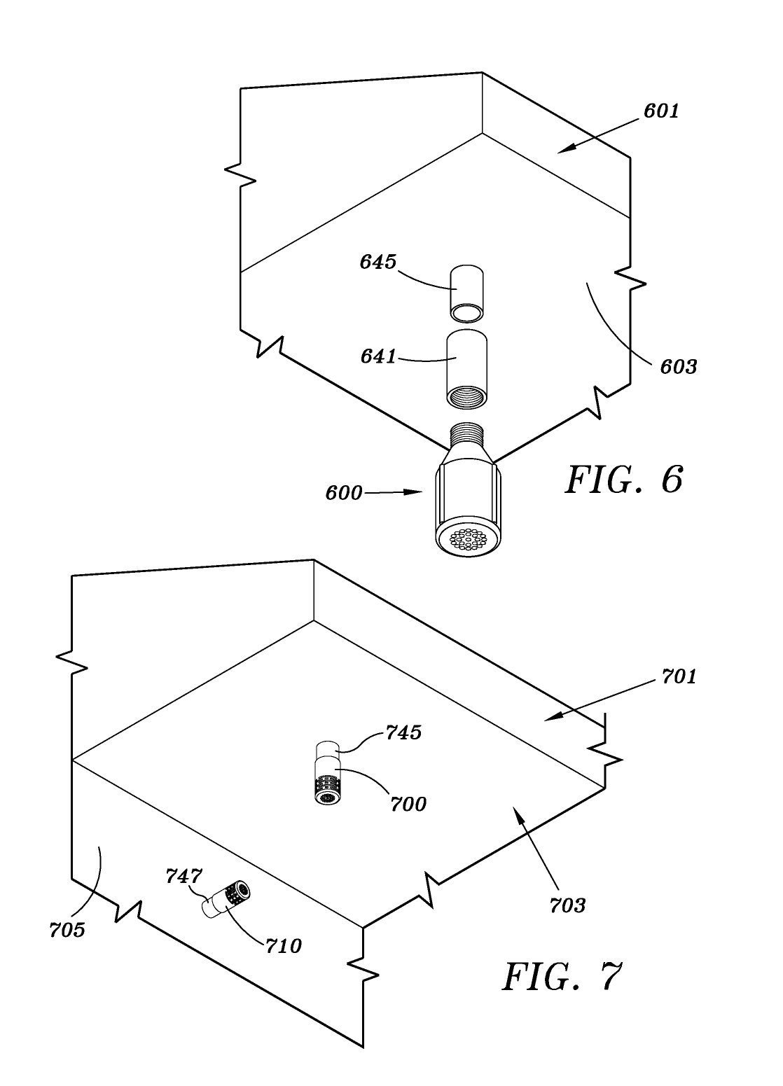

FIG. 6 depicts an adapter conduit 641 used to attach the pipe cap 600 to the terminal end of the drainage pipe 645. The drainage pipe 645 can protrude from the overhang 603 of a roof 601 (as shown). It is not always the case that the end of the drainage pipe is configured to attach to the pipe cap. For example, the connector of the pipe cap 600 may be of a different size or configuration than the end of the drainage pipe. In such cases, an adapter conduit 641, can be used to connect the pipe cap 600 to the drainage pipe 645.

As shown in FIG. 7, one or more drainage pipes 745, 747 can protrude from a building structure at the overhang 703 of a roof 701 and/or through a side wall 705 of the building structure. A first pipe cap 700 can be connected or otherwise attached directly to a first drainage pipe 745 that is protruding from the overhang 703 portion of a roof 701. A second pipe cap 710 can be connected or otherwise attached directly to a second drainage pipe 747 protruding from the sidewall 705 of the building structure.

FIG. 8 depicts a side view of an alternative embodiment of a pipe cap 800. One or more openings 811a, 811b can be disposed through the walls of the pipe cap 800. As shown in FIG. 8, one or more openings 811b can be disposed through the side walls or main body 801 of the pipe cap 800 and one or more openings 811a can be disposed through the face 807 of the pipe cap 800. The openings 811a, 811b can be elongated in shape. The openings 811a, 811b can vary in shape from one another. The openings 811a, 811b can be configured to allow maximum drainage through the pipe cap 800 while adequately preventing insects and rodents from passing through the openings 811a, 811b.

FIG. 9 depicts a cross-section view of a pipe cap 900 disposed on a drainage pipe 945. A method for using the pipe cap 900 can include connecting to or otherwise disposing on to the drainage pipe 945 by tightly fitting the pipe cap 900 onto the drainage pipe 945. In at least one other embodiment, the pipe cap 900 can be connected to the drainage pipe 945 via glue, paste, rubber cement, PVC adhesive, or any other adhesive. Once the pipe cap 900 is connected to the drainage pipe 945, fluid (eg., condensate fluid, water) can be directed from the condenser coils of an HVAC system, through the drainage pipe 945, and then through the pipe cap 900. The pipe cap 900, by way of the openings 911 disposed through a portion thereof, can be used to prevent large solid items from passing into and/or out of the drain pipe 945.

The piping cap can be made of copper, steel, polyvinyl chloride (PVC), chlorinated polyvinyl chloride (CPVC), or acrylonitrile butadiene styrene (ABS), carbon steel (galvanized or non-galvanized), impact tested carbon steel, low temperature services carbon steel, stainless steel, malleable iron, non-ferrous metals, non-metallic composites (e.g., ABS, fiber-reinforced plastic (FRP), PVC, HDPE, tempered glass), alloy steel, a variety of plastic composites, or any combination thereof.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges may appear in one or more claims below. All numerical values are “about” or “approximately” the indicated value, and take into account numerical error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent.

While the foregoing is directed to embodiments of the present invention, other and further embodiments of the invention may be devised without departing from the basic scope thereof, and the scope thereof is determined by the claims that follow. Moreover, an ordinary person having skill in the art should understand that this invention is applicable in a many types of drainage systems, and the invention is not limited to a condenser drainage system.

What is claimed is:

1. A pipe cap, comprising:
a body comprising one or more openings disposed therein, and
a connector, wherein the connector is configured to connect to a drain pipe.

2. The pipe cap of claim 1, wherein the body is spherical in shape.

3. The pipe cap of claim 1, wherein the body comprises five or more openings disposed therein.

4. The pipe cap of claim 1, wherein one or more ridges are disposed on the main body.

5. The pipe cap of claim 1, wherein the one or more openings in the pipe cap is configured to prevent insects from passing therethrough.

6. A pipe cap, comprising:
an elongated body having a first end and a second end,
a face disposed about the first end, wherein the face comprises one or more openings disposed therein, and
a connector disposed about the second end, wherein the connector is configured to connect to a drain pipe.

7. The pipe cap of claim 6, wherein one or more ridges are disposed about the elongated body.

8. The pipe cap of claim 6, wherein the one or more openings are configured to prevent rodents from passing into the pipe cap.

9. The pipe cap of claim 6, wherein one or more openings are disposed in the side walls of the elongated body.

10. A pipe cap system, comprising:
an body having a first end and a second end,
a face disposed about the first end, wherein the face comprises one or more openings disposed therein,
a connector disposed about the second end, and
a conduit, wherein the conduit is configured to attach the pipe cap to a drainage pipe.

11. The piping cap of claim 10, wherein the second end of the body comprises a threaded connector.

12. The pipe cap system of claim 10, wherein the conduit further comprises a flange.
